(19) United States
(12) Patent Application Publication
(10) Pub. No.: US 2012/0213991 A1
(43) Pub. Date: Aug. 23, 2012

(54) PRESSURE-SENSITIVE ADHESIVE LAYER FOR OPTICAL FILM, PRESSURE-SENSITIVE ADHESIVE OPTICAL FILM, AND IMAGE DISPLAY

(75) Inventors: Kunihiro Inui, Ibaraki-shi (JP); Toshitsugu Hosokawa, Ibaraki-shi (JP); Takaaki Ishii, Ibaraki-shi (JP); Masayuki Satake, Ibaraki-shi (JP)

(73) Assignee: NITTO DENKO CORPORATION, Ibaraki-shi, Osaka (JP)

(21) Appl. No.: 13/503,282

(22) PCT Filed: Sep. 1, 2010
(86) PCT No.: PCT/JP2010/064927

§ 371 Date: Apr. 20, 2012

(30) Foreign Application Priority Data
Oct. 23, 2009 (JP) 2009-244427

(51) Int. Cl. C09J 7/02; B32B 7/12; C09J 133/12; B05D 5/10

(52) U.S. Cl. 428/343; 427/208.4; 526/329.7

(57) ABSTRACT

A pressure-sensitive adhesive layer for an optical film of the invention which is formed by applying an aqueous dispersion pressure-sensitive adhesive include an aqueous dispersion containing a base polymer dispersed in water, and then drying the applied aqueous dispersion pressure-sensitive adhesive, wherein the aqueous dispersion comprises a product obtained by polymerizing a monomer or monomers in water in the presence of a surfactant and a radical polymerization initiator, and the content of the surfactant is from 0.3 to 5 parts by weight based on 100 parts by weight of the monomer or monomers, when the pressure-sensitive adhesive layer is allowed to stand in water at 23° C. for one week and to separate into a water-soluble component and a water-insoluble component, the content of the water-insoluble component in the pressure-sensitive adhesive layer is from 95 to 99% by weight, and the content of the surfactant in the water-soluble component is 50% by weight or less based on the amount of the water-soluble component. The pressure-sensitive adhesive layer for an optical film has high durability so that foaming and peeling can be suppressed even under high temperature or high humidity environment.

### TECHNICAL FIELD

The invention relates to a pressure-sensitive adhesive layer for an optical film formed from an aqueous dispersion pressure-sensitive adhesive. The invention also relates to a pressure-sensitive adhesive optical film including an optical film and the pressure-sensitive adhesive layer provided on the optical film. The invention further relates to an image display, such as a liquid crystal display device, an organic electroluminescence (EL) display device, or a plasma display panel (PDP), which is produced using the pressure-sensitive adhesive optical film. Examples of the optical film that may be used include a polarizing plate, a retardation plate, an optical compensation film, a brightness enhancement film, and a laminate of any combination thereof.

### BACKGROUND ART

A liquid crystal display or the like has an image-forming mechanism in which polarizing elements are essentially placed on both sides of the liquid crystal cell, and generally, polarizing plates are attached as the polarizing elements. Besides polarizing plates, various optical elements for improving display quality have been used in a liquid crystal panel. For example, there are used a retardation plate for preventing discoloration, a viewing angle expansion film for improving the viewing angle of the liquid crystal display, and a brightness enhancement film for enhancing the contrast of the display. These films are generically called optical films.

When such optical films are attached to a liquid crystal cell, a pressure-sensitive adhesive is generally used. In the process of bonding an optical film and a liquid crystal cell or optical films together, a pressure-sensitive adhesive is generally used to bond the materials together so that optical loss can be reduced. In such a case, a pressure-sensitive adhesive optical film including an optical film and a pressure-sensitive adhesive layer previously formed on one side of the optical film from a pressure-sensitive adhesive composition is generally used, because it has some advantages such as no need for a drying process to fix the optical film.

Since the optical film used in the pressure-sensitive adhesive optical film can easily shrink or expand under heating or humidifying conditions, the pressure-sensitive adhesive optical film can easily separate or peel after it is bonded to a liquid crystal cell. Therefore, the pressure-sensitive adhesive layer is required to have durability against heating, humidification, and so on.

Conventionally, organic solvent-containing pressure-sensitive adhesives have generally been used in forming pressure-sensitive adhesive layers for the pressure-sensitive adhesive optical film. To address the problem with durability, it is proposed that if an organic solvent-containing pressure-sensitive adhesive is used to form the pressure-sensitive adhesive layer of a pressure-sensitive adhesive optical film, the gel fraction of the pressure-sensitive adhesive should be controlled to fall within a specific range, so that durability against peeling and the like can be improved (Patent Documents 1 and 2).

In recent years, solvent-free pressure-sensitive adhesives, which are produced with no organic solvent, have been developed aggressively in view of a reduction in global environmental loading or an improvement in process stability. Known solvent-free pressure-sensitive adhesives typically include aqueous dispersion pressure-sensitive adhesives containing a pressure-sensitive adhesive polymer component dispersed in water used as a dispersion medium. Unfortunately, since aqueous dispersion pressure-sensitive adhesives generally contain a surfactant, such as an emulsifying agent or a dispersing agent, as a water-soluble, dispersion-stabilizing component, pressure-sensitive adhesive layers made from such aqueous dispersion pressure-sensitive adhesives can be easily foamed under heating conditions due to the influence of the water-soluble component, and can often suffer from peeling or the like under moisture conditions, so that they have a durability problem. There are proposed different aqueous dispersion pressure-sensitive adhesives with improved durability (Patent Documents 3, 4, and 5).

### PRIOR ART DOCUMENTS

### Patent Documents

Patent Document 1: JP-A No. 2003-034781
Patent Document 2: JP-A No. 2004-091500
Patent Document 3: JP-A No. 2005-206689
Patent Document 4: JP-A No. 2007-016194
Patent Document 5: JP-A No. 2007-254721

### SUMMARY OF THE INVENTION

### Problems to be Solved by the Invention

The aqueous dispersion pressure-sensitive adhesive described in Patent Document 3 or 4 contains polymer emulsion particles in which the emulsion is formed using a reactive emulsifying agent, and a silane coupling agent or an epoxy group-containing silane compound. This pressure-sensitive adhesive is used to form a pressure-sensitive adhesive layer in which a crosslinked structure is formed. Unfortunately, although the crosslinked structure can somewhat increase durability, the pressure-sensitive adhesive layer cannot have sufficiently improved durability, because hydroxyl groups are produced from the silane coupling agent or the epoxy group-containing silane compound in the pressure-sensitive adhesive layer, so that the pressure-sensitive adhesive containing such a compound tends to have a relatively high content of water-soluble components and the content of the surfactant in the water-soluble components also tends to be high. In addition, since the aqueous dispersion pressure-sensitive adhesive contains a water-soluble component such as the surfactant, satisfactory durability against heating and humidification is difficult to achieve only by increasing the degree of crosslinkage of the pressure-sensitive adhesive layer. In the examples of Patent Document 3 or 4, because an azo compound is used as a radical polymerization initiator and because the molecular weight of polymer emulsion particles does not increase so much, the particles have a relatively low gel fraction and a relatively large amount of low molecular weight components, so that the pressure-sensitive adhesive layer may have a relatively low content of water-insoluble components. In addition, when an azo compound is used, its ability to be copolymerized with a reactive emulsifying agent is low, and the content of water-soluble components remaining in the pressure-sensitive adhesive layer is relatively high.

Patent Document 5 discloses that an acryl-based polymer is obtained by polymerization of an acrylic monomer in the presence of a rosin-based tackifier resin and a non-reactive surfactant and that a pressure-sensitive adhesive layer with a controlled water-soluble component content of 3% by weight or less is produced using an emulsion-type pressure-sensitive adhesive composed mainly of the above acryl-based polymer. Unfortunately, this pressure-sensitive adhesive, which contains a rosin-based tackifier resin, can be easily foamed and has low durability against heating, and the content of water-soluble components remaining in this pressure-sensitive adhesive layer is also high. Patent Document 5 also discloses that the emulsion-type pressure-sensitive adhesive has an adhesive strength of 6 N/25 mm or more with respect to a polyethylene plate, which is a nonpolar substrate, at a peel angle of 180°. Conversely, it is considered that this indicates that the emulsion-type pressure-sensitive adhesive disclosed in Patent Document 5 cannot have a reliable adhesive strength for bonding to a glass substrate, which is a polar substrate, for use in a liquid crystal panel or the like. It is therefore considered that the emulsion-type pressure-sensitive adhesive disclosed in Patent Document 5 cannot ensure an adequate adhesive strength for a liquid crystal panel or cannot have satisfactory durability to serve as an optical film-forming pressure-sensitive adhesive.

An object of the invention is to provide a pressure-sensitive adhesive layer for an optical film that is applicable to an optical film, is formed from an aqueous dispersion pressure-sensitive adhesive, and has high durability so that foaming and peeling can be suppressed even under high temperature or high humidity environment.

Another object of the invention is to provide a pressure-sensitive adhesive optical film including an optical film and the pressure-sensitive adhesive layer for an optical film placed on at least one side of the optical film. A further object of the invention is to provide an image display including the pressure-sensitive adhesive optical film.

### Means for Solving the Problems

As a result of earnest studies to solve the above problems, the inventors have accomplished the invention based on the finding that the pressure-sensitive adhesive layer for an optical film described below can solve the problems.

The invention relates to a pressure-sensitive adhesive layer for an optical film, which is formed by applying an aqueous dispersion pressure-sensitive adhesive including an aqueous dispersion containing a base polymer dispersed in water, and then drying the applied aqueous dispersion pressure-sensitive adhesive, wherein

the aqueous dispersion includes a product obtained by polymerizing a monomer or monomers in water in the presence of a surfactant and a radical polymerization initiator, and

the content of the surfactant is from 0.3 to 5 parts by weight based on 100 parts by weight of the monomer or monomers,

when the pressure-sensitive adhesive layer is allowed to stand in water at 23° C. for one week and to separate into a water-soluble component and a water-insoluble component, the content of the water-insoluble component in the pressure-sensitive adhesive layer is from 95 to 99% by weight, and

the content of the surfactant in the water-soluble component is 50% by weight or less based on the amount of the water-soluble component.

The pressure-sensitive adhesive layer for an optical film preferably has a crosslinked structure.

In the pressure-sensitive adhesive layer for an optical film, the surfactant in the aqueous dispersion pressure-sensitive adhesive used for forming the pressure-sensitive adhesive layer is preferably a reactive surfactant having a radical-polymerizable functional group.

In the pressure-sensitive adhesive layer for an optical film, the monomer or monomers in the aqueous dispersion pressure-sensitive adhesive used for forming the pressure-sensitive adhesive layer preferably include a polyfunctional monomer.

In the pressure-sensitive adhesive layer for an optical film, the aqueous dispersion pressure-sensitive adhesive used for forming the pressure-sensitive adhesive layer preferably contains a crosslinking agent.

In the pressure-sensitive adhesive layer for an optical film, the content of the surfactant in the aqueous dispersion pressure-sensitive adhesive used for forming the pressure-sensitive adhesive layer is preferably from 0.3 to 2 parts by weight based on 100 parts by weight of the monomer or monomers.

In the pressure-sensitive adhesive layer for an optical film, the aqueous dispersion in the aqueous dispersion pressure-sensitive adhesive is preferably a polymer emulsion obtained by emulsion polymerization.

In the pressure-sensitive adhesive layer for an optical film, the base polymer in the aqueous dispersion pressure-sensitive adhesive is preferably a (meth)acryl-based polymer produced using at least a (meth)acrylic ester as the monomer or monomers.

The invention also relates to a pressure-sensitive adhesive optical film including an optical film and the pressure-sensitive adhesive layer for an optical film placed on at least one side of the optical film.

The invention also relates to an image display including at least one piece of the pressure-sensitive adhesive optical film.

### Effects of the Invention

The pressure-sensitive adhesive layer for an optical film of the invention is formed from an aqueous dispersion pressure-sensitive adhesive and has a water-insoluble component content controlled within the specified range (95 to 99% by weight) so that it has improved durability.

In the pressure-sensitive adhesive layer of the invention, the content of the water-insoluble component is controlled within the specified range, and the content of the surfactant in the water-soluble component of the pressure-sensitive adhesive layer is also controlled within the specified range (50% by weight or less). A common aqueous dispersion pressure-sensitive adhesive contains a water-soluble component such as a surfactant. Therefore, a relatively large amount of a water-soluble component remains in a pressure-sensitive adhesive layer formed from such an aqueous dispersion pressure-sensitive adhesive, which has an adverse effect on durability. It has been found that in particular, a surfactant in such a water-soluble component is undesirable for improvement of durability. The invention controls the content of the surfactant used in the production of the aqueous dispersion pressure-sensitive adhesive, which is used to form the pressure-sensitive adhesive layer, so that the content of the surfactant in the water-soluble component of the pressure-sensitive adhesive layer is controlled within the above range. Therefore, the pressure-sensitive adhesive layer of the invention has satisfactory durability against heating and humidification.

### EMBODIMENTS FOR CARRYING OUT THE INVENTION

The pressure-sensitive adhesive layer for an optical film of the invention includes a product formed by a process including applying an aqueous dispersion pressure-sensitive adhesive and then drying it. The pressure-sensitive adhesive layer is so regulated that when subjected to the process of allowing it to stand in water at 23° C. for one week to separate it into a water-soluble component and a water-insoluble component, it satisfies the requirement that the content of the water-insoluble component in the pressure-sensitive adhesive layer is from 95 to 99% by weight.

If the content of the water-insoluble component in the pressure-sensitive adhesive is more than 99% by weight, the pressure-sensitive adhesive layer will be so hard that it may have insufficient flexibility. This may often cause remarkable peeling or tunneling to degrade heat durability or moisture durability. If a pressure-sensitive adhesive layer with a water-insoluble component content of more than 99% by weight is formed using an aqueous dispersion pressure-sensitive adhesive, the aqueous dispersion pressure-sensitive adhesive will become unstable, so that thickening or gelation may occur when a load is applied to the adhesive during coating, defoaming, or the like, which may make coating impossible. If the content of the water-insoluble component in the pressure-sensitive adhesive layer is less than 95% by weight, the pressure-sensitive adhesive layer will have low water resistance so that moisture durability may decrease due to adhesive displacement or the like. The content of the water-insoluble component in the pressure-sensitive adhesive layer is preferably from 96 to 99% by weight, in particular, preferably from 97 to 99% by weight.

In addition, the pressure-sensitive adhesive layer of the invention is so regulated that the content of the surfactant in the water-soluble component separated from the water-insoluble component is 50% by weight or less based on the amount of the water-soluble component. Setting the surfactant content at 50% by weight or less can improve durability. In contrast, if the surfactant content is more than 50% by weight, foaming will be more likely to occur under heating conditions, and peeling or the like will be more likely to occur under humidifying conditions, so that durability will be insufficient. The surfactant content is preferably 40% by weight or less, more preferably 30% by weight or less.

For example, a crosslinked structure may be formed in the pressure-sensitive adhesive layer so that the content of the water-insoluble component in the pressure-sensitive adhesive layer can be increased to fall within the above range. The crosslinked structure can be formed by intra-particle crosslinking using a polyfunctional monomer in combination with a monomer capable of forming base polymer particles to be dispersed in an aqueous dispersion, or by inter-particle crosslinking using a crosslinking agent which is added to the polymer particles and has two or more functional groups reactive with the particles. In view of heat durability, intra-particle crosslinking is preferred to inter-particle crosslinking. In addition, a reactive surfactant may be used to form the polymer particles, which is preferred to increase the content of the water-insoluble component within the above range. The content of the surfactant in the water-soluble component can be regulated by the content of the surfactant used in the production of an aqueous dispersion or the type of the surfactant (e.g., selection of a reactive surfactant having a radical-polymerizable functional group).

The aqueous dispersion pressure-sensitive adhesive contains an aqueous dispersion, which is a dispersion of a base polymer in water. For example, the aqueous dispersion pressure-sensitive adhesive may be a rubber-based pressure-sensitive adhesive, an acrylic pressure-sensitive adhesive, a vinyl alkyl ether-based pressure-sensitive adhesive, a polyvinyl alcohol-based pressure-sensitive adhesive, a polyvinyl pyrrolidone-based pressure-sensitive adhesive, or a polyacrylamide-based pressure-sensitive adhesive. Among them, an acrylic pressure-sensitive adhesive is preferably used because it has a high level of optical transparency and weather resistance or heat resistance and exhibits appropriate wettability and pressure-sensitive adhesive properties such as appropriate cohesiveness and tackiness.

The aqueous dispersion can be obtained by polymerizing a monomer or monomers in water in the presence of a surfactant and a radical polymerization initiator. The polymerization process may be emulsion polymerization, suspension polymerization, or dispersion polymerization. A polymer emulsion, a polymer suspension, and a polymer dispersion are obtained in the cases of emulsion polymerization, suspension polymerization, and dispersion polymerization, respectively. The type of the pressure-sensitive adhesive polymer and the polymerization process are selected depending on the type of the pressure-sensitive adhesive. The surfactant is appropriately selected depending on each polymerization process, and an emulsifying agent may be selected as the surfactant in the case of emulsion polymerization, or a dispersing agent may be selected as the surfactant in the case of suspension polymerization.

In an embodiment of the invention, the aqueous dispersion for the aqueous dispersion pressure-sensitive adhesive is preferably an emulsion-type pressure-sensitive adhesive including a polymer emulsion obtained by emulsion polymerization. An emulsion-type acrylic pressure-sensitive adhesive is particularly preferred. Hereinafter, the aqueous dispersion pressure-sensitive adhesive according to the invention is described with reference to an aqueous dispersion-type acrylic pressure-sensitive adhesive.

An aqueous dispersion-type acrylic pressure-sensitive adhesive includes a (meth)acryl-based polymer as a base polymer, for example, which can be obtained in the form of a copolymer emulsion by emulsion polymerization of monomer components, which contain alkyl (meth)acrylate as a main component, in the presence of a surfactant (an emulsifying agent) and a radical polymerization initiator. The term “alkyl (meth)acrylate” refers to alkyl acrylate and/or alkyl methacrylate, and “(meth)” is used in the same meaning in the description.

For example, the alkyl (meth)acrylate used to form the main skeleton of the (meth)acryl-based polymer may have a straight or branched chain alkyl group of 1 to 20 carbon atoms. For example, the alkyl group may be methyl, ethyl, propyl, isopropyl, n-butyl, isobutyl, sec-butyl, tert-butyl, pentyl, neopentyl, isoamyl, hexyl, heptyl, 2-ethylhexyl, isooctyl, nonyl, isononyl, decyl, isodecyl, dodecyl, tridecyl, tetradecyl, pentadecyl, hexadecyl, heptadecyl, octadecyl, nonadecyl, or eicosyl. These may be used alone or in any combination. In an embodiment of the invention, the alkyl (meth)acrylate preferably has a water solubility in a certain range from the standpoint of emulsion polymerization reactivity, and structurally, the alkyl (meth)acrylate preferably has an alkyl group of 1 to 12 carbon atoms.

Besides the alkyl (meth)acrylate, one or more copolymerizable monomers having an unsaturated double bond-containing polymerizable functional group such as a (meth)acryloyl group or a vinyl group may be incorporated into the (meth)acryl-based polymer by copolymerization for purposes such as stabilization of the aqueous dispersion, improvement in the adhesion of the pressure-sensitive adhesive layer to a base material such as an optical film, and improvement in the initial tackiness to adherends.

Examples of the copolymerizable monomer include, but are not limited to, carboxyl group-containing monomers such as (meth)acrylic acid, itaconic acid, maleic acid, fumaric acid, crotonic acid, carboxyethyl acrylate, and carboxypentyl acrylate; acid anhydride group-containing monomers such as maleic anhydride and itaconic anhydride; alicyclic hydrocarbon esters of (meth)acrylic acid, such as cyclohexyl (meth)acrylate, bornyl (meth)acrylate, and isobornyl (meth)acrylate; aryl (meth)acrylate such as phenyl (meth)acrylate; vinyl esters such as vinyl acetate and vinyl propionate; styrene monomers such as styrene; epoxy group-containing monomers such as glycidyl (meth)acrylate and methylglycidyl (meth)acrylate; hydroxyl group-containing monomers such as 2-hydroxyethyl acrylate and 2-hydroxypropyl acrylate; nitrogen atom-containing monomers such as (meth)acrylamide, N,N-dimethyl(meth)acrylamide, N,N-diethyl(meth)acrylamide, N-isopropyl(meth)acrylamide, N-butyl(meth)acrylamide, N-methylol(meth)acrylamide, N-methylolpropane(meth)acrylamide, (meth) acryloylmorpholine, aminoethyl (meth)acrylate, N,N-dimethylaminoethyl (meth)acrylate, and tert-butylaminoethyl (meth)acrylate; alkoxy group-containing monomers such as methoxyethyl (meth)acrylate and ethoxyethyl (meth)acrylate; cyano group-containing monomers such as acrylonitrile and methacrylonitrile; functional monomers such as 2-methacryloyloxyethyl isocyanate; olefin monomers such as ethylene, propylene, isoprene, butadiene, and isobutylene; vinyl ether monomers such as vinyl ether; halogen atom-containing monomers such as vinyl chloride; and other monomers including vinyl group-containing heterocyclic compounds such as N-vinylpyrrolidone, N-(1-methylvinyl)pyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, and N-vinylmorpholine, and N-vinylcarboxylic acid amides.

Examples of the copolymerizable monomer also include maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth) acryloyloxymethylenesuccinimide, N-(meth)acryloyl-6-oxyhexamethylenesuccinimide, and N-(meth)acryloyl-8-oxyoctamethylenesuccinimide; and sulfonic acid group-containing monomers such as styrenesulfonic acid, allylsulfonic acid, 2-(meth)acrylamido-2-methylpropanesulfonic acid, (meth) acrylamidopropanesulfonic acid, sulfopropyl (meth)acrylate, and (meth) acryloyloxynaphthalenesulfonic acid.

The copolymerizable monomer may also be a phosphate group-containing monomer. For example, the phosphate group-containing monomer may be a phosphate group-containing monomer represented by formula (I) below or a salt thereof.

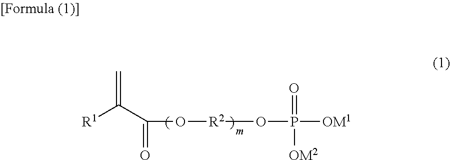

In formula (I), R¹ represents a hydrogen atom or a methyl group, R² represents an alkylene group of 1 to 4 carbon atoms, m represents an integer of 2 or more, and M¹ and M² each independently represent a hydrogen atom or a cation.

In formula (1), m is 2 or more, preferably 4 or more, generally 40 or less, and m represents the degree of polymerization of the oxyalkylene groups. The polyoxyalkylene group may be a polyoxyethylene group or a polyoxypropylene group, and these polyoxyalkylene groups may comprise random, block, or graft units. The cation of the salt of the phosphate group is typically, but not limited to, an inorganic cation such as an alkali metal such as sodium or potassium or an alkaline-earth metal such as calcium or magnesium, or an organic cation such as a quaternary amine.

Examples of the copolymerizable monomer also include glycol acrylate monomers such as polyethylene glycol (meth)acrylate, polypropylene glycol (meth)acrylate, methoxyethylene glycol (meth)acrylate, and methoxypolypropylene glycol (meth)acrylate; and other monomers such as acrylic ester monomers containing a heterocyclic ring or a halogen atom, such as tetrahydrofurfuryl (meth)acrylate and fluoro(meth)acrylate.

A polyfunctional monomer may also be used as the copolymerizable monomer for a purpose such as control of the gel fraction of the aqueous dispersion pressure-sensitive adhesive. The polyfunctional monomer may be a compound having two or more unsaturated double bonds such as those in (meth)acryloyl groups or vinyl groups. Examples that may also be used include (meth)acrylate esters of polyhydric alcohols, such as (mono or poly)alkylene glycol di(meth)acrylates including (mono or poly)ethylene glycol di(meth)acrylates such as ethylene glycol di(meth)acrylate, diethylene glycol di(meth)acrylate, triethylene glycol di(meth)acrylate, trimethylolpropane tri(meth)acrylate, and tetraethylene glycol di(meth)acrylate, (mono or poly)propylene glycol di(meth)acrylate such as propylene glycol di(meth)acrylate, neopentyl glycol di(meth)acrylate, 1,6-hexanediol di(meth)acrylate, pentaerythritol di(meth)acrylate, trimethylolpropane tri(meth)acrylate, pentaerythritol tri(meth)acrylate, and dipentaerythritol hexa(meth)acrylate; polyfunctional vinyl compounds such as divinylbenzene; and compounds having a reactive unsaturated double bond, such as allyl (meth)acrylate and vinyl (meth)acrylate. The polyfunctional monomer may also be a compound having a polyester, epoxy or urethane skeleton to which two or more unsaturated double bonds are added in the form of functional groups such as (meth)acryloyl groups or vinyl groups in the same manner as the monomer component, such as polyester (meth)acrylate, epoxy (meth)acrylate, or urethane (meth)acrylate.

The polyfunctional monomer may also be a silane coupling agent-type unsaturated monomer having at least one unsaturated double bond such as that in a (meth)acryloyl group or a vinyl group and having an alkoxysilyl group. Silane coupling agent-type unsaturated monomers include silane coupling agent-type (meth)acrylate monomers and silane coupling agent-type vinyl monomers. For example, silane coupling agent-type (meth)acrylate monomers include (meth)acryloyloxyalkyl-trialkoxysilanes such as (meth) acryloyloxymethyl-trimethoxysilane, (meth) acryloyloxymethyl-triethoxysilane, 2-(meth)acryloyloxyethyl-trimethoxysilane, 2-(meth)acryloyloxyethyl-triethoxysilane, 3-(meth)acryloyloxypropyl-trimethoxysilane, 3-(meth)acryloyloxypropyl-triethoxysilane, 3-(meth) acryloyloxypropyl-tripropoxysilane, 3-(meth)acryloyloxypropyl-triisopropoxysilane, and 3-(meth)acryloyloxypropyl-tributoxysilane; (meth) acryloyloxyalkyl-alkyldialkoxysilanes such as (meth) acryloyloxymethyl-methyldimethoxysilane, (meth) acryloyloxymethyl-methyldiethoxysilane, 2-(meth)acryloyloxyethyl-methyldimethoxysilane, 2-(meth)acryloyloxyethyl-methyldiethoxysilane, 3-(meth)acryloyloxypropyl-methyldimethoxysilane, 3-(meth)acryloyloxypropyl-methyldiethoxysilane, 3-(meth)acryloyloxypropyl-methyldipropoxysilane, 3-(meth)acryloyloxypropyl-methyldiisopropoxysilane, 3-(meth)acryloyloxypropyl-methyldibutoxysilane, 3-(meth)acryloyloxypropyl-ethyldimethoxysilane, 3-(meth)acryloyloxypropyl-ethyldiethoxysilane, 3-(meth)acryloyloxypropyl-ethyldipropoxysilane, 3-(meth)acryloyloxypropyl-ethyldiisopropoxysilane, 3-(meth)acryloyloxypropyl-ethyldibutoxysilane, 3-(meth)acryloyloxypropyl-propyldimethoxysilane, and 3-(meth)acryloyloxypropyl-propyldiethoxysilane; and (meth)acryloyloxyalkyl-dialkyl(mono)alkoxysilanes corresponding to these monomers. For example, silane coupling agent-type vinyl monomers include vinyltrialkoxysilanes such as vinyltrimethoxysilane, vinyltriethoxysilane, vinyltripropoxysilane, vinyltriisopropoxysilane, and vinyltributoxysilane, and vinylalkyldialkoxysilanes and vinyldialkylalkoxysilanes corresponding thereto; vinylalkyltrialkoxysilanes such as vinylmethyltrimethoxysilane, vinylmethyltriethoxysilane, β-vinylethyltrimethoxysilane, β-vinylethyltriethoxysilane, γ-vinylpropyltrimethoxysilane, γ-vinylpropyltriethoxysilane, γ-vinylpropyltripropoxysilane, γ-vinylpropyltriisopropoxysilane, and γ-vinylpropyltributoxysilane, and (vinylalkyl)alkyldialkoxysilanes and (vinylalkyl)dialkyl(mono)alkoxysilanes corresponding thereto.

Among these copolymerizable monomers, carboxyl group-containing monomers such as acrylic acid, epoxy group-containing monomers, hydroxyl group-containing monomers, or nitrogen atom-containing monomers having an N-methylol moiety or the like are preferably used in view of stabilization of the aqueous dispersion (such as the polymer emulsion) or the like and reliable adhesion of the pressure-sensitive adhesive layer, which is formed from the aqueous dispersion pressure-sensitive adhesive containing the aqueous dispersion, to a glass panel as an adherend. In particular, carboxyl group-containing monomers are preferred. Preferably the polyfunctional monomer, in particular, preferably the silane coupling agent-type unsaturated monomer is used as the copolymerizable monomer.

The (meth)acryl-based polymer may include alkyl (meth)acrylate as a main component, and the content of the alkyl (meth)acrylate component may be 50% by weight or more, preferably 60% by weight or more, more preferably 70% by weight or more, based on the total amount of all monomer components. The upper limit of the content is typically, but not limited to, 100% by weight, preferably 99% by weight, more preferably 98% by weight. If the content of the alkyl (meth)acrylate component is less than 50% by weight, the adhesive properties of the pressure-sensitive adhesive layer, such as the adhesive strength, may be degraded in some cases.

The content of the copolymerizable monomer is typically less than 50% by weight, preferably less than 40% by weight, more preferably less than 30% by weight, based on the total amount of all monomer components. The content of the copolymerizable monomer may be appropriately selected depending on the type of each copolymerizable monomer. Based on the total amount of all monomers, for example, the content of a carboxyl group-containing monomer as the copolymerizable monomer is preferably from 0.1 to 6% by weight, and the content of an epoxy group-containing monomer, a hydroxyl group-containing monomer, or a nitrogen atom-containing monomer having an N-methylol moiety or the like as the copolymerizable monomer is preferably from 0.5 to 5% by weight. The content of the polyfunctional monomer used as the copolymerizable monomer is preferably 10% by weight or less, preferably from 0.1 to 3% by weight, based on the total amount of all monomer components. The content of the silane coupling agent-type unsaturated monomer is preferably from 0.005 to 0.2% by weight.

The emulsion polymerization of the monomer components may be performed by a conventional method including emulsifying the monomer components in water. This method prepares an aqueous dispersion (polymer emulsion) containing a (meth)acryl-based polymer as a base polymer. In the emulsion polymerization, for example, the monomer components, a surfactant (an emulsifying agent), and a radical polymerization initiator, and optionally a chain transfer agent or the like are mixed as appropriate. More specifically, for example, a known emulsion polymerization method may be employed, such as a batch mixing method (batch polymerization method), a monomer dropping method, or a monomer emulsion dropping method. In a monomer dropping method, continuous dropping or divided dropping is appropriately selected. These methods may be appropriately combined. While reaction conditions and so on may be appropriately selected, for example, the polymerization temperature is preferably from about 40 to about 95° C., and the polymerization time is preferably from about 30 minutes to about 24 hours.

The surfactant (emulsifying agent) for use in the emulsion polymerization may be, but not limited to, any of various surfactants commonly used in emulsion polymerization. While an anionic or nonionic surfactant is generally used as the surfactant, the water-insoluble component of the pressure-sensitive adhesive layer can be more increased and more easily controlled within the above range using an anionic surfactant than using a nonionic surfactant. In addition, the content of the surfactant in the water-soluble component of the pressure-sensitive adhesive layer can be more easily controlled to be low using an anionic surfactant than using a nonionic surfactant.

The surfactant to be used is typically an anionic surfactant or a nonionic surfactant. Examples of the anionic surfactant include higher fatty acid salts such as sodium oleate; alkylarylsulfonate salts such as sodium dodecylbenzenesulfonate; alkylsulfate ester salts such as sodium laurylsulfate and ammonium laurylsulfate; polyoxyethylene alkyl ether sulfate ester salts such as sodium polyoxyethylene lauryl ether sulfate; polyoxyethylene alkyl aryl ether sulfate ester salts such as sodium polyoxyethylene nonyl phenyl ether sulfate; alkyl sulfosuccinic acid ester salts such as sodium monooctyl sulfosuccinate, sodium dioctyl sulfosuccinate, and sodium polyoxyethylene lauryl sulfosuccinate, and derivatives thereof; and polyoxyethylene distyrenated phenyl ether sulfate ester salts. Examples of the nonionic surfactant include polyoxyethylene alkyl ethers such as polyoxyethylene lauryl ether and polyoxyethylene stearyl ether; polyoxyethylene alkyl phenyl ethers such as polyoxyethylene octyl phenyl ether and polyoxyethylene nonyl phenyl ether; sorbitan higher fatty acid esters such as sorbitan monolaurate, sorbitan monostearate, and sorbitan trioleate; polyoxyethylene sorbitan higher fatty acid esters such as polyoxyethylene sorbitan monolaurate; polyoxyethylene higher fatty acid esters such as polyoxyethylene monolaurate and polyoxyethylene monostearate; glycerin higher fatty acid esters such as oleic acid monoglyceride and stearic acid monoglyceride; and polyoxyethylene-polyoxypropylene block copolymers, and polyoxyethylene distyrenated phenyl ether.

Besides the above non-reactive surfactants, a reactive surfactant having a radical-polymerizable functional group containing an ethylenic unsaturated double bond may be used as the surfactant. The use of the reactive surfactant is more preferred than the use of the non-reactive surfactant, because when the reactive surfactant is used, the content of the water-insoluble component in the pressure-sensitive adhesive layer can be made higher, and the content of the surfactant in the water-soluble component of the pressure-sensitive adhesive layer can be made smaller. The reactive surfactant may be a radical-polymerizable surfactant prepared by introducing a radical-polymerizable functional group (radically reactive group) such as a propenyl group or an allyl ether group into the anionic surfactant or the nonionic surfactant. These surfactants may be appropriately used alone or in any combination. Among these surfactants, the radical-polymerizable surfactant having a radical-polymerizable functional group is preferably used in view of the stability of the aqueous dispersion or the durability of the pressure-sensitive adhesive layer.

Examples of anionic reactive surfactants include alkyl ether surfactants (examples of commercially available products include AQUALON KH-05, KH-10, and KH-20 manufactured by Dai-ichi Kogyo Seiyaku Co., Ltd., ADEKA REASOAP SR-10N and SR-20N manufactured by ADEKA CORPORATION, LATEMUL PD-104 manufactured by Kao Corporation, and others); sulfosuccinic acid ester surfactants (examples of commercially available products include LATEMUL S-120, S-120A, S-180P, and S-180A manufactured by Kao Corporation and ELEMINOL JS-2 manufactured by Sanyo Chemical Industries, Ltd., and others); alkyl phenyl ether surfactants or alkyl phenyl ester surfactants (examples of commercially available products include AQUALON H-2855A, H-3855B, H-3855C, H-3856, HS-05, HS-10, HS-20, HS-30, BC-05, BC-10, and BC-20 manufactured by Dai-ichi Kogyo Seiyaku Co., Ltd., and ADEKA REASOAP SDX-222, SDX-223, SDX-232, SDX-233, SDX-259, SE-10N, and SE-20N manufactured by ADEKA CORPORATION); (meth)acrylate sulfate ester surfactants (examples of commercially available products include ANTOX MS-60 and MS-2N manufactured by Nippon Nyukazai Co., Ltd., ELEMINOL RS-30 manufactured by Sanyo Chemical Industries Co., Ltd., and others); and phosphoric acid ester surfactants (examples of commercially available products include H-3330PL manufactured by Dai-ichi Kogyo Seiyaku Co., Ltd. ADEKA REASOAP PP-70 manufactured by ADEKA CORPORATION, and others). Examples of nonionic reactive surfactants include alkyl ether surfactants (examples of commercially available products include ADEKA REASOAP ER-10, ER-20, ER-30, and ER-40 manufactured by ADEKA CORPORATION, LATEMUL PD-420, PD-430, and PD-450 manufactured by Kao Corporation, and others); alkyl phenyl ether surfactants or alkyl phenyl ester surfactants (examples of commercially available products include AQUALON RN-10, RN-20, RN-30, and RN-50 manufactured by Dai-ichi Kogyo Seiyaku Co., Ltd., ADEKA REASOAP NE-10, NE-20, NE-30, and NE-40 manufactured by ADEKA CORPORATION, and others); and (meth)acrylate sulfate ester surfactants (examples of commercially available products include RMA-564, RMA-568, and RMA-1114 manufactured by Nippon Nyukazai Co., Ltd, and others).

The content of the surfactant used is from 0.3 to 5 parts by weight based on 100 parts by weight of the monomer components including the alkyl (meth)acrylate as a main component. When the content of the surfactant is in this range, the content of the water-insoluble component of the pressure-sensitive adhesive layer can be set high, and the content of the surfactant in the water-soluble component of the pressure-sensitive adhesive layer can be set low, which is preferred for the improvement of durability. In addition, adhesive properties, polymerization stability, mechanical stability, etc. can also be improved. The content of the surfactant is more preferably from 0.3 to 2 parts by weight.

The radical polymerization initiator may be, but not limited to, any known radical polymerization initiator commonly used in emulsion polymerization. Examples include azo initiators such as 2,2′-azobisisobutylonitrile, 2,2′-azobis(2-methylpropionamidine)disulfate, 2,2′-azobis(2-methylpropionamidine)dihydrochloride, 2,2′-azobis(2-amidinopropane)dihydrochloride, and 2,2′-azobis[2-(2-imidazoline-2-yl)propane]dihydrochloride; persulfate initiators such as potassium persulfate and ammonium persulfate; peroxide initiators such as benzoyl peroxide, tert-butyl hydroperoxide, and hydrogen peroxide; substituted ethane initiators such as phenyl-substituted ethane; and carbonyl initiators such as aromatic carbonyl compounds. These polymerization initiators may be appropriately used alone or in any combination. If desired, the emulsion polymerization may be performed using a redox system initiator, in which a reducing agent is used in combination with the polymerization initiator. This makes it easy to accelerate the emulsion polymerization rate or to perform the emulsion polymerization at low temperature. Examples of such a reducing agent include reducing organic compounds such as ascorbic acid, erythorbic acid, tartaric acid, citric acid, glucose, and metal salts of formaldehyde sulfoxylate or the like; reducing inorganic compounds such as sodium thiosulfate, sodium sulfite, sodium bisulfite, and sodium metabisulfite; and ferrous chloride, Rongalite, and thiourea dioxide. Among these polymerization initiators, non-azo polymerization initiators are preferred in order to keep at a low level the low-molecular-weight component of the polymer particles in the aqueous dispersion and to increase the water-insoluble component of the pressure-sensitive adhesive layer. As compared with azo polymerization initiators, non-azo polymerization initiators have a high ability to be copolymerized with the reactive surfactant and can keep at a low level the water-soluble component remaining in the pressure-sensitive adhesive layer. In particular, the non-azo polymerization initiators are preferably persulfate salt initiators.

The content of the radical polymerization initiator is typically from about 0.02 to about 1 part by weight, preferably from 0.02 to 0.5 parts by weight, more preferably from 0.08 to 0.3 parts by weight, based on 100 parts by weight of the monomer components, while it is appropriately selected. If it is less than 0.02 parts by weight, the radical polymerization initiator may be less effective. If it is more than 1 part by weight, the (meth)acryl-based polymer in the aqueous dispersion (polymer emulsion) may have a reduced molecular weight, so that the aqueous dispersion pressure-sensitive adhesive may have reduced durability. In the case of a redox system initiator, the reducing agent is preferably used in an amount of 0.01 to 1 part by weight based on 100 parts by weight of the total amount of the monomer components.

A chain transfer agent is optionally used to control the molecular weight of the water-dispersible (meth)acryl-based polymer. In general, chain transfer agents commonly used in emulsion polymerization are used. Examples include 1-dodecanthiol, mercaptoacetic acid, 2-mercaptoethanol, 2-ethylhexyl thioglycolate, 2,3-dimercapto-1-propanol, mercaptopropionic acid esters, and other mercaptans. These chain transfer agents may be appropriately used alone or in any combination. For example, the content of the chain transfer agent is from 0.001 to 0.3 parts by weight based on 100 parts by weight of the monomer components.

According to the emulsion polymerization described above, the (meth)acryl-based polymer can be prepared in the form of an aqueous dispersion (emulsion). The average particle size of such a water-dispersible (meth)acryl-based polymer is typically controlled in the range of 0.05 to 3 μm, preferably in the range of 0.05 to 1 μm. If the average particle size is less than 0.05 μm, the aqueous dispersion pressure-sensitive adhesive may have increased viscosity, and if it is more than 1 μm, adhesiveness between particles may decrease so that cohesive strength may decrease.

When the (meth)acryl-based polymer in the aqueous dispersion contains a carboxyl group-containing monomer component or the like for maintaining the stability of the aqueous dispersion, the carboxyl group-containing monomer component or the like should preferably be neutralized. For example, the neutralization can be performed using ammonia, an alkali metal hydroxide, or the like.

In general, the water-dispersible (meth)acryl-based polymer according to the invention preferably has a weight average molecular weight of 1,000,000 or more. In particular, the weight average molecular weight is preferably from 1,000,000 to 4,000,000 in view of heat resistance or moisture resistance. A weight average molecular weight of less than 1,000,000 is not preferred, because with such a molecular weight, heat resistance or moisture resistance may decrease. The pressure-sensitive adhesive obtained by the emulsion polymerization is preferred because the polymerization mechanism can produce very high molecular weight. It should be noted, however, that the pressure-sensitive adhesive obtained by the emulsion polymerization generally has a high gel content and cannot be subjected to GPC (gel permeation chromatography) measurement, which means that it is often difficult to identify the molecular weight by actual measurement.

In the aqueous dispersion pressure-sensitive adhesive according to the invention, the polymer-containing aqueous dispersion may contain a crosslinking agent. The crosslinking agent for use in the aqueous dispersion-type acrylic pressure-sensitive adhesive may be one commonly used, such as an isocyanate crosslinking agent, an epoxy crosslinking agent, an oxazoline crosslinking agent, an aziridine crosslinking agent, a carbodiimide crosslinking agent, or a metal chelate crosslinking agent. When a functional group-containing monomer is used, these crosslinking agents have the effect of reacting with the functional group incorporated in the (meth)acryl-based polymer to form crosslinkage.

While the content ratio between the base polymer and the crosslinking agent is not restricted, about 10 parts by weight or less (solid basis) of the crosslinking agent is generally added to 100 parts by weight (solid basis) of the base polymer. The content of the crosslinking agent is preferably from 0.001 to 10 parts by weight, more preferably from 0.01 to 5 parts by weight.

If necessary, the aqueous dispersion pressure-sensitive adhesive of the invention may further appropriately contain any of various additives such as viscosity adjusting agent, releasing adjusting agent, tackifiers, plasticizers, softener, fillers including glass fibers, glass beads, metal power, or any other inorganic powder, pigments, colorants (pigments, dyes or the likes), pH adjusting agent (acid or base), antioxidants, ultraviolet ray absorbing agents, and silane coupling agents, without departing from the objects of the invention. The aqueous dispersion pressure-sensitive adhesive may also contain fine particles to form a light-diffusing pressure-sensitive adhesive layer. These additives may also be added in the form of dispersion.

The pressure-sensitive adhesive layer for an optical film of the invention is formed from the aqueous dispersion pressure-sensitive adhesive. The pressure-sensitive adhesive layer can be formed by a process including applying the aqueous dispersion pressure-sensitive adhesive to a backing substrate (an optical film or a release film) and then drying it. The pressure-sensitive adhesive for an optical film of the invention is the pressure-sensitive adhesive layer formed by such a process, in which the content of remaining monomers should be controlled to be from 5 to 100 ppm.

The pressure-sensitive adhesive optical film of the invention includes an optical film and the pressure-sensitive adhesive layer placed on one or both sides of the optical film. The pressure-sensitive adhesive optical film of the invention can be formed by a process including applying the aqueous dispersion pressure-sensitive adhesive to an optical film or a release film and drying it. When the pressure-sensitive adhesive layer is formed on a release film, the pressure-sensitive adhesive layer is transferred and bonded onto an optical film.

The applying process of the aqueous dispersion pressure-sensitive adhesive may be performed using any of various methods. Examples include roll coating, kiss roll coating, gravure coating, reverse coating, roll brushing, spray coating, dip roll coating, bar coating, knife coating, air knife coating, curtain coating, lip coating, and extrusion coating with a die coater or the like.

In the application process, the amount of the application is so controlled that a pressure-sensitive adhesive layer with a desired thickness (post-drying thickness) can be formed. The thickness (post-drying thickness) of the pressure-sensitive adhesive layer is generally set to be from about 1 to about 100 μm, preferably from 5 to 50 μm, more preferably from 10 to 40 μm.

In the process of forming the pressure-sensitive adhesive layer, the aqueous dispersion pressure-sensitive adhesive coating is then subjected to drying. The drying temperature is generally from about 80 to about 170° C., preferably from 80 to 160° C., and the drying time is generally from about 0.5 to 30 minutes, preferably from 1 to 10 minutes.

Examples of the material used to form the release film include a plastic film such as a polyethylene, polypropylene, polyethylene terephthalate, or polyester film, a porous material such as paper, fabric, or nonwoven fabric, and an appropriate thin material such as a net, a foamed sheet, a metal foil, and a laminate thereof. A plastic film is preferably used, because of its good surface smoothness.

Any plastic film capable of protecting the pressure-sensitive adhesive layer may be used, examples of which include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the release film is generally from about 5 to about 200 μm, preferably from about 5 to about 100 μm. If necessary, the separator may be subjected to a release treatment and an antifouling treatment with a silicone, fluoride, long-chain alkyl, or fatty acid amide release agent, silica powder or the like, or subjected to an antistatic treatment of coating type, kneading and mixing type, vapor-deposition type, or the like. In particular, when the surface of the release film is appropriately subjected to a release treatment such as a silicone treatment, a long-chain alkyl treatment, or a fluorine treatment, the releasability from the pressure-sensitive adhesive layer can be further increased.

The pressure-sensitive adhesive layer may be exposed. In such a case, the pressure-sensitive adhesive layer may be protected by the release film until it is actually used. The release-treated film may be used as is as a separator for a pressure-sensitive adhesive optical film, so that the process can be simplified.

An optical film may also be coated with an anchor layer or subjected to any adhesion-facilitating treatment such as a corona treatment or a plasma treatment so as to have improved adhesion to a pressure-sensitive adhesive layer, and then the pressure-sensitive adhesive layer may be formed. The surface of the pressure-sensitive adhesive layer may also be subjected to an adhesion-facilitating treatment.

Materials that may be used to form the anchor layer preferably include an anchoring agent selected from polyurethane, polyester, polymers containing an amino group in the molecule, and polymers containing an oxazolinyl group in the molecule, in particular, preferably polymers containing an amino group in the molecule and polymers containing an oxazolinyl group in the molecule. Polymers containing an amino group in the molecule and polymers containing an oxazolinyl group in the molecule allow the amino group in the molecule or an oxazolinyl group in the molecule to react with a carboxyl group or the like in the pressure-sensitive adhesive or to make an interaction such as an ionic interaction, so that good adhesion can be ensured.

Examples of polymers containing an amino group in the molecule include polyethyleneimine, polyallylamine, polyvinylamine, polyvinylpyridine, polyvinylpyrrolidine, and a polymer of an amino group-containing monomer such as dimethylaminoethyl acrylate.

The optical film is, but not limited to the kinds, used for forming image display such as liquid crystal display. A polarizing plate is exemplified. A polarizing plate including a polarizer and a transparent protective film provided on one side or both sides of the polarizer is generally used.

A polarizer is, but not limited to, various kinds of polarizer may be used. As a polarizer, for example, a film that is uniaxially stretched after having dichromatic substances, such as iodine and dichromatic dye, absorbed to hydrophilic polymer films, such as polyvinyl alcohol-based film, partially formalized polyvinyl alcohol-based film, and ethylene-vinyl acetate copolymer-based partially saponified film; polyene-based alignment films, such as dehydrated polyvinyl alcohol and dehydrochlorinated polyvinyl chloride, etc. may be mentioned. In these, a polyvinyl alcohol-based film on which dichromatic materials such as iodine, is absorbed and aligned after stretched is suitably used. Thickness of polarizer is, but not limited to, generally about 5 to about 80 μm.

A polarizer that is uniaxially stretched after a polyvinyl alcohol-based film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol-based film may be dipped in water and rinsed if needed. By rinsing polyvinyl alcohol-based film with water, effect of preventing un-uniformity, such as unevenness of dyeing, is expected by making polyvinyl alcohol-based film swelled in addition that also soils and blocking inhibitors on the polyvinyl alcohol-based film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film is generally laminated to one side of the polarizer with the adhesive layer, but thermosetting resins or ultraviolet curing resins such as (meth)acrylic, urethane, acrylic urethane, epoxy, or silicone resins may be used to other side of the polarizer for the transparent protective film. The transparent protective film may also contain at least one type of any appropriate additive. Examples of the additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, still more preferably from 60 to 98% by weight, particularly preferably from 70 to 97% by weight. If the content of the thermoplastic resin in the transparent protective film is 50% by weight or less, high transparency and other properties inherent in the thermoplastic resin can fail to be sufficiently exhibited.

An optical film of the invention may be exemplified as other optical layers, such as a reflective plate, a transflective plate, a retardation plate (a half wavelength plate and a quarter wavelength plate included), and a viewing angle compensation film, which may be used for formation of a liquid crystal display etc. These are used in practice as an optical film, or as one layer or two layers or more of optical layers laminated with polarizing plate.

Although an optical film with the above described optical layer laminated to the polarizing plate may be formed by a method in which laminating is separately carried out sequentially in manufacturing process of a liquid crystal display or the like, an optical film in a form of being laminated beforehand has an outstanding advantage that it has excellent stability in quality and assembly workability, and thus manufacturing processes ability of a liquid crystal display or the like may be raised. Proper adhesion means, such as a pressure-sensitive adhesive layer, may be used for laminating. On the occasion of adhesion of the above described polarizing plate and other optical films, the optical axis may be set as a suitable configuration angle according to the target retardation characteristics or the like.

The pressure-sensitive adhesive optical film of the invention is preferably used to form various types of image displays such as liquid crystal displays. Liquid crystal displays may be produced according to conventional techniques. Specifically, liquid crystal displays are generally produced by appropriately assembling a display panel such as a liquid crystal cell and the pressure-sensitive adhesive optical film and optionally other components such as a lighting system and incorporating a driving circuit according to any conventional technique, except that the pressure-sensitive adhesive optical film of the invention is used. Any type of liquid crystal cell may also be used such as a TN type, an STN type, a n type, a VA type and an IPS type.

Suitable liquid crystal displays, such as liquid crystal display with which the above pressure-sensitive adhesive optical film has been provided on one side or both sides of the display panel such as a liquid crystal cell, and with which a backlight or a reflective plate is used for a lighting system may be manufactured. In this case, the pressure-sensitive adhesive optical film may be provided on one side or both sides of the display panel such as a liquid crystal cell. When providing the pressure-sensitive adhesive optical films on both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

### EXAMPLES

Hereinafter, the invention is more specifically described with reference to the Examples, which however are not intended to limit the invention. Unless otherwise stated, “parts” and “%” in each example are all by weight.

### Example 1

### Preparation of Emulsion-Type Acrylic Pressure-Sensitive Adhesive

To a vessel were added 950 parts of butyl acrylate, 50 parts of acrylic acid, and 0.3 parts of 3-methacryloyloxypropyl-triethoxysilane (KBM-503, manufactured by Shin-Etsu Chemical Co., Ltd.) and mixed to obtain a monomer mixture. Subsequently, 24 parts of HITENOL NF-08 (manufactured by Dai-ichi Kogyo Seiyaku Co., Ltd.) as a non-reactive surfactant (anionic) and 382 parts of ion-exchanged water were added to 600 parts of the monomer mixture prepared with the above composition, and stirred at 6,000 (rpm/min) for 5 minutes using a homo mixer (manufactured by PRIMIX Corporation), so that a monomer emulsion was obtained.

Subsequently, 200 parts of the monomer emulsion prepared as described above and 330 parts of ion-exchanged water were added to a reaction vessel equipped with a condenser tube, a nitrogen-introducing tube, a thermometer, a dropping funnel, and a stirring blade. Subsequently, after the space in the reaction vessel was replaced with nitrogen sufficiently, 0.6 parts of ammonium persulfate was added to the vessel, and polymerization was carried out under stirring at 60° C. for 1 hour. Subsequently, the remaining part of the monomer emulsion was added dropwise over 3 hours while the reaction vessel was kept at 60° C., and then polymerization was carried out for 3 hours, so that a polymer emulsion with a solids concentration of 46% was obtained. Subsequently, after the polymer emulsion was cooled to room temperature, 30 parts of ammonia water with a concentration of 10% was added thereto, so that an emulsion-type acrylic pressure-sensitive adhesive with the pH and solids content adjusted to 8 and 46%, respectively, was obtained.

### (Formation of Pressure-Sensitive Adhesive Layer and Preparation of Pressure-Sensitive Adhesive-Type Polarizing Plate)

The emulsion-type acrylic pressure-sensitive adhesive was applied to a release film (DIAFOIL MRF-38, manufactured by Mitsubishi Chemical Polyester Co., Ltd., a polyethylene terephthalate substrate) with a die coater so that a 20 μm thick coating could be formed after drying, and then the coating was dried at 120° C. for 5 minutes to form a pressure-sensitive adhesive layer. The pressure-sensitive adhesive layer was bonded to a polarizing plate (SEG-DU (product name) manufactured by NITTO DENKO CORPORATION), so that a pressure-sensitive adhesive-type polarizing plate was obtained.

### Example 2

An emulsion-type acrylic pressure-sensitive adhesive was prepared as in Example 1, except that 24 parts of AQUALON HS-10 (manufactured by Dai-ichi Kogyo Seiyaku Co., Ltd.) was used as a reactive surfactant (anionic) in place of HITENOL NF-08 in the process of preparing the emulsion-type acrylic pressure-sensitive adhesive. Using the pressure-sensitive adhesive, a pressure-sensitive adhesive layer and a pressure-sensitive adhesive-type polarizing plate were also formed and prepared as in Example 1.

### Example 3

An emulsion-type acrylic pressure-sensitive adhesive was prepared as in Example 1, except that 6 parts of AQUALON HS-10 (manufactured by Dai-ichi Kogyo Seiyaku Co., Ltd.) was used as a reactive surfactant (anionic) in place of HITENOL NF-08 in the process of preparing the emulsion-type acrylic pressure-sensitive adhesive. Using the pressure-sensitive adhesive, a pressure-sensitive adhesive layer and a pressure-sensitive adhesive-type polarizing plate were also formed and prepared as in Example 1.

### Example 4

An emulsion-type acrylic pressure-sensitive adhesive was prepared as in Example 1, except that 6 parts of AQUALON RN-20 (manufactured by Dai-ichi Kogyo Seiyaku Co., Ltd.) was used as a reactive surfactant (anionic) in place of HITENOL NF-08 in the process of preparing the emulsion-type acrylic pressure-sensitive adhesive. Using the pressure-sensitive adhesive, a pressure-sensitive adhesive layer and a pressure-sensitive adhesive-type polarizing plate were also formed and prepared as in Example 1.

### Example 5

An emulsion-type acrylic pressure-sensitive adhesive was prepared as in Example 1, except that 6 parts of AQUALON HS-10 (manufactured by Dai-ichi Kogyo Seiyaku Co., Ltd.) was used as a reactive surfactant (anionic) in place of HITENOL NF-08 in the process of preparing the emulsion-type acrylic pressure-sensitive adhesive and that 3-methacryloyloxypropyl-triethoxysilane (KBM-503, manufactured by Shin-Etsu Chemical Co., Ltd.) was not added to the monomer mixture. Using the pressure-sensitive adhesive, a pressure-sensitive adhesive layer and a pressure-sensitive adhesive-type polarizing plate were also formed and prepared as in Example 1.

### Example 6

An emulsion-type acrylic pressure-sensitive adhesive was prepared as in Example 1, except that 24 parts of EMULGEN A-60 (manufactured by Kao Corporation), a non-reactive surfactant (nonionic), was used in place of HITENOL NF-08 in the process of preparing the emulsion-type acrylic pressure-sensitive adhesive. Using the pressure-sensitive adhesive, a pressure-sensitive adhesive layer and a pressure-sensitive adhesive-type polarizing plate were also formed and prepared as in Example 1.

### Example 7

An emulsion-type acrylic pressure-sensitive adhesive was prepared as in Example 1, except that 3-methacryloyloxypropyl-triethoxysilane (KBM-503, manufactured by Shin-Etsu Chemical Co., Ltd.) was not added to the monomer mixture in the process of preparing the emulsion-type acrylic pressure-sensitive adhesive and that 1 part of CARBODILITE E-03A (manufactured by Nisshinbo Chemical Inc.) was further added as a crosslinking agent to 100 parts (solid basis) of the resulting emulsion-type acrylic pressure-sensitive adhesive. Using the pressure-sensitive adhesive, a pressure-sensitive adhesive layer and a pressure-sensitive adhesive-type polarizing plate were also formed and prepared as in Example 1.

### Example 8

An emulsion-type acrylic pressure-sensitive adhesive was prepared as in Example 3, except that 1 part of CARBODILITE E-03A (manufactured by Nisshinbo Chemical Inc.) was further added as a crosslinking agent to 100 parts (solid basis) of the emulsion-type acrylic pressure-sensitive adhesive obtained in Example 3. Using the pressure-sensitive adhesive, a pressure-sensitive adhesive layer and a pressure-sensitive adhesive-type polarizing plate were also formed and prepared as in Example 1.

### Comparative Example 1

An emulsion-type acrylic pressure-sensitive adhesive was prepared as in Example 1, except that 0.1 parts of AQUALON HS-10 (manufactured by Dai-ichi Kogyo Seiyaku Co., Ltd.) was used as a reactive surfactant (anionic) in place of HITENOL NF-08 in the process of preparing the emulsion-type acrylic pressure-sensitive adhesive. Using the pressure-sensitive adhesive, a pressure-sensitive adhesive layer and a pressure-sensitive adhesive-type polarizing plate were also formed and prepared as in Example 1.

### Comparative Example 2

An emulsion-type acrylic pressure-sensitive adhesive was prepared as in Example 1, except that the amount of HITENOL NF-08 as a reactive non-surfactant (anionic) was changed to 36 parts in the process of preparing the emulsion-type acrylic pressure-sensitive adhesive. Using the pressure-sensitive adhesive, a pressure-sensitive adhesive layer and a pressure-sensitive adhesive-type polarizing plate were also formed and prepared as in Example 1.

### Comparative Example 3

An emulsion-type acrylic pressure-sensitive adhesive was prepared as in Example 1, except that 3-methacryloyloxypropyl-triethoxysilane (KBM-503, manufactured by Shin-Etsu Chemical Co., Ltd.) was not added to the monomer mixture in the process of preparing the emulsion-type acrylic pressure-sensitive adhesive, 60 parts of AQUALON HS-10 (manufactured by Dai-ichi Kogyo Seiyaku Co., Ltd.) was used as a reactive surfactant (anionic) in place of HITENOL NF-08, and 10 parts of KBE-403 (manufactured by Shin-Etsu Chemical Co., Ltd.) as an epoxy silane coupling agent was further added to 100 parts (solid basis) of the resulting emulsion-type acrylic pressure-sensitive adhesive. Using the pressure-sensitive adhesive, a pressure-sensitive adhesive layer and a pressure-sensitive adhesive-type polarizing plate were also formed and prepared as in Example 1.

### Comparative Example 4

An emulsion-type acrylic pressure-sensitive adhesive was prepared as in Example 1, except that the amount of 3-methacryloyloxypropyl-triethoxysilane (KBM-503, manufactured by Shin-Etsu Chemical Co., Ltd.) in the monomer mixture was changed to 0.05 parts in the process of preparing the emulsion-type acrylic pressure-sensitive adhesive, the amount of HITENOL NF-08 as a surfactant was changed to 36 parts, and 20 parts of KBE-403 (manufactured by Shin-Etsu Chemical Co., Ltd.) as an epoxy silane coupling agent was further added to 100 parts (solid basis) of the resulting emulsion-type acrylic pressure-sensitive adhesive. Using the pressure-sensitive adhesive, a pressure-sensitive adhesive layer and a pressure-sensitive adhesive-type polarizing plate were also formed and prepared as in Example 1.

### Comparative Example 5

In a vessel were mixed 50.5 parts of 2-ethylhexyl acrylate, 40.5 parts of butyl acrylate, 5 parts of ethyl acrylate, 3 parts of methyl methacrylate, 1 part of acrylic acid, 10 parts of a rosin-based resin (SUPER ESTER A-125, manufactured by ARAKAWA CHEMICAL INDUSTRIES, LTD.) as a tackifier resin, and 5 parts of a terpene-based resin (YS RESIN PX1250, manufactured by YASUHARA CHEMICAL Co., Ltd.), so that the tackifier resin was dissolved in the monomers to obtain a mixture of them. To the mixture were added 1 part of polyoxyethylene alkyl ether sulfate (with an alkyl group of 12 carbon atoms and an oxyethylene group addition number of 18) as a water-soluble, non-reactive surfactant and 50 parts of ion-exchanged water, and stirred using a homo mixer, so that a monomer emulsion was obtained. Subsequently, 49 parts of ion-exchanged water and 0.1 parts of the polyoxyethylene alkyl ether sulfate were added to a reaction vessel equipped with a condenser tube, a nitrogen-introducing tube, a thermometer, and a stirrer. Under a nitrogen atmosphere, the internal temperature was raised to 78° C. with stirring, and 2.1 parts of an aqueous 5% ammonium persulfate solution was added. After 5 minutes, the monomer emulsion and 6.3 parts of an aqueous 5% ammonium persulfate solution were added dropwise from different dropping tanks over 4 hours, and polymerization was carried out. After the dropwise addition was completed, the mixture was kept at 80° C. for 3 hours and then cooled to 40° C. or less. Thereafter, the product was neutralized with 10% ammonia water, so that an emulsion-type acrylic pressure-sensitive adhesive with the pH adjusted to 8 was obtained. The emulsion-type acrylic pressure-sensitive adhesive had a non-volatile content of 50.1%.

The pressure-sensitive adhesive-type polarizing plates obtained in the examples and the comparative examples were evaluated as described below. The results of the evaluation are shown in Table 1.

<Method for Measuring Water-Insoluble component of Pressure-Sensitive Adhesive Layer>

The emulsion-type acrylic pressure-sensitive adhesive prepared in each example was poured into a release film-attached glass vessel so that a 0.5 mm thick coating could be formed after drying, and allowed to stand at room temperature (23° C.) for 1 week, so that a pressure-sensitive adhesive layer was obtained. The pressure-sensitive adhesive layer was cut into a sample piece of a 4 cm² size, the weight (initial weight) of which was measured. The sample was placed in a 100 ml bottle filled with pure water, and allowed to stand at room temperature (23° C.) for 1 week. After the standing, the sample was taken out of the bottle and dried at 130° C. for 2 hours. The weight (weight after drying) of the sample was measured, and the content of the water-insoluble component in the pressure-sensitive adhesive layer was calculated from the following formula: The water-insoluble component content (%)=(the weight after drying/the initial weight)×100

### <Method for Measuring the Content of Surfactant in Water-Soluble Component of Pressure-Sensitive Adhesive Layer>

Besides the water-insoluble component of the pressure-sensitive adhesive layer, an aqueous solution containing a water-soluble component separated from the pressure-sensitive adhesive was left in the bottle, from which the sample was removed. The aqueous solution was analyzed, in which the amount of the surfactant in the water-soluble component was determined. The content of the surfactant in the water-soluble component was calculated from the formula below using the amount of the water-soluble component (the amount of the fraction other than the water-insoluble component) calculated from the measurement of the water-insoluble component and the determined amount of the surfactant by the following formula: The content of the surfactant (%)=(the determined amount of the surfactant/the amount of the water-soluble component)×100

The amount of the surfactant in the water-soluble component was determined using HPLC (Water 2690, manufactured by Waters Corporation) and MS (ZMD2000, manufactured by Micromass Limited). The HPLC-MS equipment was an analyzer using a combination of HPLC with high separation performance and MS with high quantification performance, and each component was separated by HPLC and identified by MS. The quantification was performed by absolute calibration method, in which the concentration of the surfactant was determined from the peak area obtained by an HPLC detector, when the amount of the surfactant in the water-soluble component was determined.

HPLC measurement conditions: The temperature of the column oven was set at 50° C., and the flow rate of the mobile phase was set at 0.3 mL/minute. The mobile phase used was an aqueous 20 mM ammonium acetate solution (liquid A) or acetonitrile (liquid B). The sample injection amount was 10 μL.

The column used was a gel filtration chromatography column (SHODEX MSpak GF-3104D, manufactured by Showa Denko K.K.) with an inner diameter of 4.6 mm, a length of 150 mm, and a particle size of 5 μm.

MS measurement conditions: The measurement was performed using electrospray ionization and SIM mode. Nitrogen was used as the desolvation gas and the cone gas at flow rates of 150 L/hour and 45 L/hour, respectively. The desolvation temperature and the ion source temperature were 330° C. and 130° C., respectively.

### [Heat Durability]

The pressure-sensitive adhesive-type polarizing plate of each of the examples and the comparative examples was cut into a 15 inch size piece, which was bonded to a 0.7 mm thick non-alkali glass plate (Corning #1737, manufactured by Corning Incorporated) and allowed to stand for 15 minutes in an autoclave at 50° C. and 0.5 MPa. Subsequently, it was treated in an atmosphere at 80° C. for 500 hours. The degree of the generation of bubbles in the pressure-sensitive adhesive layer of the treated pressure-sensitive adhesive-type polarizing plate was evaluated with an optical microscope according to the criteria below based on the number and size of the bubbles observed (the bubbles existing before the treatment were omitted when the evaluation was performed).

5: Bubbles with a maximum length of 200 μm or more were not observed per 1 cm².
4: 5 or less bubbles with a maximum length of 200 μm or more were observed per 1 cm².
3: 6 to 10 bubbles with a maximum length of 200 μm or more were observed per 1 cm².
2: 11 to 100 bubbles with a maximum length of 200 μm or more were observed per 1 cm².
1: 101 or more bubbles with a maximum length of 200 μm or more were observed per 1 cm².

### [Moisture Durability]

The pressure-sensitive adhesive-type polarizing plate of each of the examples and the comparative examples was cut into a 15 inch size piece, which was bonded to a 0.7 mm thick non-alkali glass plate (Corning #1737, manufactured by Corning Incorporated) and allowed to stand for 15 minutes in an autoclave at 50° C. and 0.5 MPa. Subsequently, it was treated under an environment at 60° C. and 90% R.H. for 500 hours. Within 24 hours after it was taken out of the environment at 60° C. and 90% R.H. and transferred to room temperature conditions (23° C. and 55% R.H.), the degree of peeling between the treated pressure-sensitive adhesive-type polarizing plate and the non-alkali glass was visually observed and evaluated according to the criteria below.

5: No peeling occurred.
4: Peeling occurred from the end of the pressure-sensitive adhesive-type polarizing plate to a site within 0.5 mm from the end.
3: Peeling occurred from the end of the pressure-sensitive adhesive-type polarizing plate to a site within 1.0 mm from the end.
2: Peeling occurred from the end of the pressure-sensitive adhesive-type polarizing plate to a site within 3.0 mm from the end.
1: Peeling occurred from the end of the pressure-sensitive adhesive-type polarizing plate to a site 3.0 mm or more from the end.

TABLE 1

| | | | | | | | B: Content | | | |
|---|---|---|---|---|---|---|---|---|---|---|
| | | | | | Crosslinking | A: Content | (%) of | | | |
| | | | | | agent/additive* | (%) of | surfactant | | | |
| | | Surfactant | | | Amount (parts) | water- | in water- | | | |
| | | | | Amount | added based on | insoluble | soluble | | | |
| | | | | (parts) | 100 parts of | component | component | | | |
| | | | | used | emulsion | in | of | | Evaluation | |
| | Presence or | | | based on | pressure- | Pressure- | sensitive | C: | Durability | |
| | absence of | | | 100 parts | sensitive | sensitive | pressure- | (100 − | | 60° C./ |
| | polyfunctional | | Ionic | of | adhesive (solid | adhesive | adhesive | A) × | | 90% |
| | monomer | Reactivity | properties | monomers | basis) | layer | layer | (B /100) | 80° C. | RH |
| Example 1 | Present | Non- | Anionic | 4 | — | 95.2 | 40 | 1.92 | 3 | 3 |
| | | reactive | | | | | | | | |
| Example 2 | Present | Reactive | Anionic | 4 | — | 96.8 | 30 | 0.96 | 4 | 4 |
| Example 3 | Present | Reactive | Anionic | 1 | — | 98.2 | 21 | 0.37 | 4 | 5 |
| Example 4 | Present | Reactive | Nonionic | 1 | — | 97.5 | 29 | 0.72 | 4 | 5 |
| Example 5 | Absent | Reactive | Anionic | 1 | — | 96.9 | 34 | 1.05 | 3 | 4 |
| Example 6 | Present | Non | Nonionic | 4 | — | 95.7 | 40 | 1.72 | 3 | 3 |
| | | reactive | | | | | | | | |
| Example 7 | Absent | Reactive | Anionic | 1 | 1 | 97.8 | 25 | 0.55 | 4 | 4 |
| Example 8 | Present | Reactive | Anionic | 1 | 1 | 98.7 | 19 | 0.24 | 5 | 5 |
| Comparative | Present | Reactive | Anionic | 0.1 | — | 99.3 | 10 | 0.07 | Aggregates were | |
| Example 1 | | | | | | | | | produced during | |
| | | | | | | | | | application. | |
| Comparative | Present | Non- | Anionic | 6 | — | 93.1 | 65 | 4.48 | 2 | 2 |
| Example 2 | | reactive | | | | | | | | |
| Comparative | Absent | Reactive | Anionic | 10 | 10 | 92.5 | 48 | 3.60 | 1 | 1 |
| Example 3 | | | | | | | | | | |
| Comparative | Present | Non- | Anionic | 6 | 20 | 92.1 | 54 | 4.27 | 2 | 2 |
| Example 4 | | reactive | | | | | | | | |
| Comparative | Absent | Non- | Anionic | 1 | — | 95.5 | 55 | 2.48 | 1 | 2 |
| Example 5 | | reactive | | | | | | | | |

With respect to the mark * in the table, the values for Examples 7 and 8 each indicate the amount of the crosslinking agent, and those for Comparative Examples 3 and 4 each indicate the amount of the silane coupling agent. The table also shows C: the measured surfactant amount ratio based on the amount of the pressure-sensitive adhesive layer, namely, C = (100 − A) × (B/100), which was calculated from A: the content (%) of the water-insoluble component in the pressure-sensitive adhesive layer and B: the content (%) of the surfactant in the water-soluble component of the pressure-sensitive adhesive layer. The value C is preferably 2 or less.

1. A pressure-sensitive adhesive layer for an optical film, which is formed by applying an aqueous dispersion pressure-sensitive adhesive comprising an aqueous dispersion containing a base polymer dispersed in water, and then drying the applied aqueous dispersion pressure-sensitive adhesive, wherein the aqueous dispersion comprises a product obtained by polymerizing a monomer or monomers in water in the presence of a surfactant and a radical polymerization initiator, and the content of the surfactant is from 0.3 to 5 parts by weight based on 100 parts by weight of the monomer or monomers, when the pressure-sensitive adhesive layer is allowed to stand in water at 23° C. for one week and to separate into a water-soluble component and a water-insoluble component, the content of the water-insoluble component in the pressure-sensitive adhesive layer is from 95 to 99% by weight, and the content of the surfactant in the water-soluble component is 50% by weight or less based on the amount of the water-soluble component.

2. The pressure-sensitive adhesive layer for an optical film according to claim 1, which has a crosslinked structure.

3. The pressure-sensitive adhesive layer for an optical film according to claim 2, wherein the surfactant is a reactive surfactant having a radical-polymerizable functional group.

4. The pressure-sensitive adhesive layer for an optical film according to claim 2, wherein the monomer or monomers include a polyfunctional monomer.

5. The pressure-sensitive adhesive layer for an optical film according to claim 2, wherein the aqueous dispersion pressure-sensitive adhesive contains a crosslinking agent.

6. The pressure-sensitive adhesive layer for an optical film according to claim 1, wherein the content of the surfactant is from 0.3 to 2 parts by weight based on 100 parts by weight of the monomer or monomers.

7. The pressure-sensitive adhesive layer for an optical film according to claim 1, wherein the aqueous dispersion in the aqueous dispersion pressure-sensitive adhesive is a polymer emulsion obtained by emulsion polymerization.

8. The pressure-sensitive adhesive layer for an optical film according to claim 1, wherein the base polymer in the aqueous dispersion pressure-sensitive adhesive is a (meth)acryl-based polymer produced using at least a (meth)acrylic ester as the monomer or monomers.

9. A pressure-sensitive adhesive optical film, comprising an optical film and the pressure-sensitive adhesive layer for an optical film according to claim 1 placed on at least one side of the optical film.

10. An image display comprising at least one piece of the pressure-sensitive adhesive optical film according to claim 9.
